(19) United States
(12) Patent Application Publication
(10) Pub. No.: US 2012/0078808 A1
(43) Pub. Date: Mar. 29, 2012

(54) PRESCRIPTIVE WELLBEING UTILIZING AN ENTERPRISE GRID

(75) Inventors: Aaron K. Baughman, Silver Spring, MD (US); Christian Eggenberger-Wang, St. Gallen (CH); Peter K. Malkin, Ardsley, NY (US); Andreas J. Schindler, Zurich (CH); Karina Zwolak, Lausanne (CH)

(73) Assignee: INTERNATIONAL BUSINESS MACHINES CORPORATION, Armonk, NY (US)

(21) Appl. No.: 12/888,940

(22) Filed: Sep. 23, 2010

(51) Int. Cl. G06Q 10/00

(52) U.S. Cl. 705/348

(57) ABSTRACT

A system and method for implementing an enterprise grid to model the wellbeing of an enterprise. The system includes a system for creating models to form the enterprise grid, wherein a set of entity models are utilized to model entities within the enterprise and a set of organizational models are utilized to model organizational aspects of the enterprise, and wherein at least one class of entity models are utilized to model humans; a system for training models; a system for receiving an input from an entity within the enterprise and forwarding the input into an associated entity model; and a system for connecting models such that an output of a source model is only directed to a target model either at a same hierarchical level or at a parent level.

### BACKGROUND

The present invention relates to managing enterprises, and more particularly, to a prescriptive wellbeing system and method for an enterprise utilizing an enterprise grid.

In almost all enterprises, there is typically a desire to achieve optimal performance. Optimal performance can only be achieved if the enterprise has a high level of “wellbeing,” i.e., all aspects of the enterprise are operating efficiently and effectively. In a corporate setting, this might mean that the company has efficient systems to streamline productivity, a well thought out and implemented IT infrastructure, effective personnel, a positive work environment, etc. Each such aspect plays a key role in allowing the company to execute business goals.

### BRIEF SUMMARY

The present invention provides a prescriptive wellbeing system and method for an enterprise using an enterprise grid. The solution utilizes models to create and maintain the enterprise grid in order to increase the wellness of an associated enterprise. The enterprise grid employs (1) entity models that model enterprise entities such as resources, computing infrastructures, humans, end to end ecosystem entities such as buildings and offices, etc.; and (2) organizational models that model business and strategic processes. Wellbeing is achieved by feeding of the epigenetic, genetic and environmental state of the entities into associated models to monitor, evaluate and alter enterprise infrastructures.

According to one embodiment of the present invention, a system for implementing an enterprise grid to model the wellbeing of an enterprise is disclosed, comprising: a system for creating models, wherein a set of entity models are utilized to model entities within the enterprise and a set of organizational models are utilized to model organizational aspects of the enterprise, and wherein at least one class of entity models are utilized to model humans; a system for connecting models to form the enterprise grid such that an output of a source model is only directed to a target model either at a same hierarchical level or to a parent level; a system for training models; and a system for receiving an input from an entity within the enterprise and forwarding the input into an associated entity model.

According to a second embodiment of the present invention, a method for implementing an enterprise grid to model an enterprise is disclosed, comprising: creating a set of models, wherein a set of entity models are utilized to model entities within the enterprise and a set of organizational models are utilized to model organizational aspects of the enterprise, and wherein at least one class of entity models are utilized to model humans; connecting models to form the enterprise grid such that an output of a source model is only directed to a target model either at a same hierarchical level or at a parent level; training models; and receiving an input from an entity within the enterprise and forwarding the input to an associated entity model.

According to a third embodiment of the present invention, a computer program product is disclosed for implementing an enterprise grid to model an enterprise, the computer program product comprising: a computer readable storage medium having computer readable program code embodied therewith, the computer readable program code comprising: program code for creating models to form the enterprise grid, wherein a set of entity models are utilized to model entities within the enterprise and a set of organizational models are utilized to model organizational aspects of the enterprise, and wherein at least one class of entity models are utilized to model humans; program code for connecting models such that an output of a source model is only directed to a target model either at a same hierarchical level or at a parent level; program code for training models; and program code for receiving an input from an entity within the enterprise and forwarding the input into an associated entity model.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings.

FIG. 1 depicts a wellbeing system for modeling, monitoring and controlling the wellbeing of an associated enterprise.

FIG. 2 depicts an illustrative enterprise grid in which organizational models inherit from entity models.

FIG. 3 depicts a system for monitoring a state of an employee based on inputs to an associated model.

FIG. 4 depicts the use of activation functions within an enterprise grid.

FIG. 5 depicts an interface for implementing and interfacing with the enterprise grid.

FIG. 6 depicts a flow chart of a method of implementing a wellness system.

The drawings are merely schematic representations, not intended to portray specific parameters of the invention. The drawings are intended to depict only typical embodiments of the invention, and therefore should not be considered as limiting the scope of the invention. In the drawings, like reference numbering represents like elements.

### DETAILED DESCRIPTION

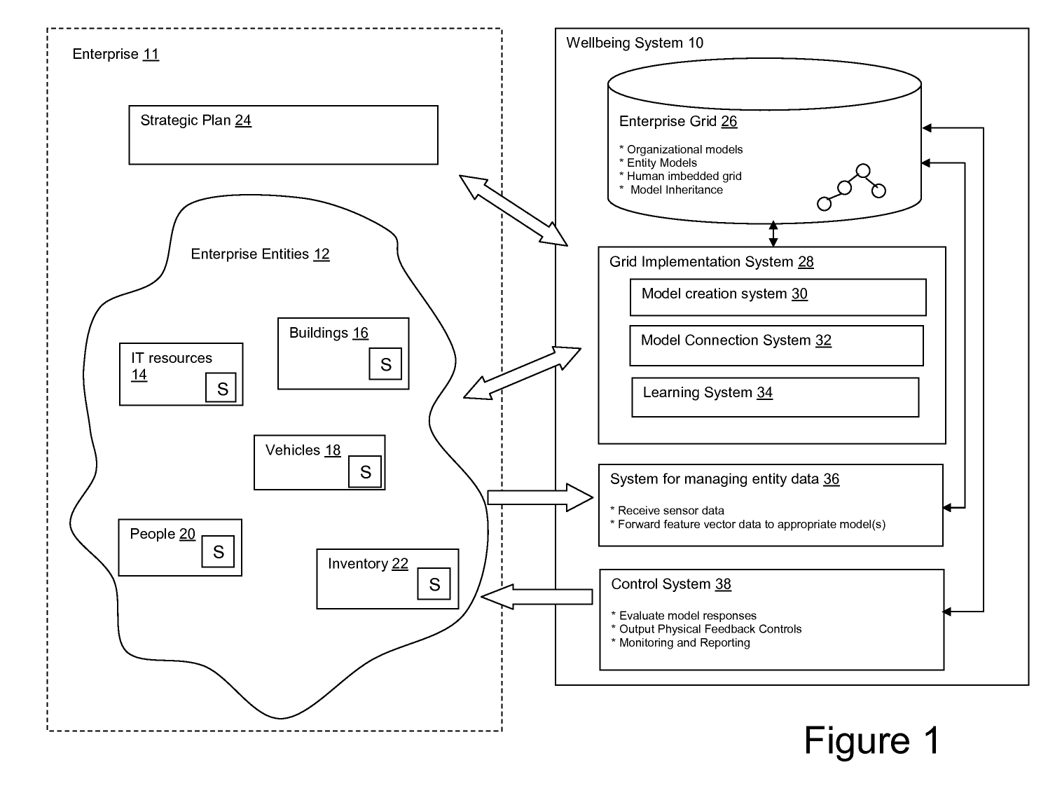

FIG. 1 depicts a wellbeing system 10 for modeling, implementing and managing an enterprise grid 26 to monitor and control the wellbeing of an associated enterprise 11. Enterprise 11 may generally comprise any organization that comprises enterprise entities 12 and a strategic plan 24, such as a corporation, a government, a university, etc. In this example, enterprise entities 12 include IT (information technology) resources 14, buildings 16, vehicles 18, people 20, and inventory 22; however it is understood that the number and type of entities may vary and could also include, e.g., offices, software, computers, employee roles, tasks, projects, departments, divisions, etc. Wellbeing refers to any performance, health, effectiveness, efficiency, etc., measure of any aspect of the enterprise 11.

Strategic plan 24 may for example comprise a business plan that determines the structure of the organization (e.g., how the entities 12 are organized within the enterprise 11), the business goals, profitability, production, environmental goals, growth, accounting, revenue, costs, strategies, etc.

Wellbeing system 10 maps each of the entities 12 and the strategic plan 24 into the enterprise grid 26. The enterprise grid 26 includes inseparable organizational (e.g., business) models and entity models. Wellbeing management is based on the constant monitoring of the epigenetic, genetic and environmental state of entities 12, such as employees, buildings, corporate assets, etc. An aspect of the invention is the extension of the enterprise grid 26 to include all types of entities 12, including both digital (e.g., IT resources 14) and organic (e.g., people 20). As such, people within the enterprise 11 are modeled and monitored along with other entities to form a Human imbedded Grid.

Enterprise grid 26 is effectively embodied in any computing infrastructure capable of implementing a set of models and their respective interactions, e.g., neural networks, etc. In the illustrative embodiment shown in FIG. 1, wellbeing system 10 includes: (1) a grid implementation system 28 for building and managing the enterprise grid 26; (2) a system for managing entity data 36; and (3) a control system 38.

Grid implementation system 28 generally includes: (1) a model creation system 30 to create and activate models within the enterprise grid; (2) a model connection system 32 to define the overall grid structure and how models connect to each other as nodes within the enterprise grid 26; and (3) a learning system 34 for training models.

Models may be implemented using any now known or later developed technique. In general, for the purposes of this disclosure, the term “model” refers to a description of an entity and/or organizational aspect of the enterprise 11 using a mathematical or computer language. Each model is a representation of the essential aspects of the entity and/or organizational aspect which presents knowledge of that system in usable form. As noted, any type of modeling may be utilized, such as linear and non-linear models, deterministic and stochastic models, neural networks, etc. Models generally contain some parameters that can be used to fit the model to the entity or system it is intended to describe. If the modeling is done by a neural network, the optimization of parameters is generally referred to as training.

Model connection system 32 provides a mechanism for connecting models such that data can flow from one model to another. Connections can be implemented, e.g., in a graph based user interface in which nodes (i.e., models) are connected with lines. As a general rule, an output of a source model can only be directed to a target model either at a same hierarchical level or at a parent level. For instance, a child model may comprise a room, and a parent model may comprise a floor of rooms. Output data generally can only flow from the room model to the floor model.

Learning system 34 (i.e., model training) may likewise be implemented in any fashion. Models may for instance be trained by inputting real or simulated data and recording the output. For instance, a given person may be tested at varying room conditions (e.g., warm/cool, humid/dry, dim/bright lighting, etc.). The person's performance under different conditions may be utilized to build a model.

The system for managing entity data 36 is responsible for collecting sensor data S from the enterprise entities 12, packaging the data into a feature vector, and forwarding the feature vector to the appropriate model within the enterprise grid. Sensor data S generally comprises epigenetic, genetic and environment data. Epigenetic data measures changes in phenotype or gene expression that is caused by something other than actual DNA/structural sequence change. For instance, an epigenetic change can be caused by something within the environment, e.g., a car that is going down the road is affected by environmental influences. If the road is wet, perhaps the Antilock Break System (ABS) will tighten—this could be viewed as an epigenetic change since the car's gene expression (e.g., chassis/parts) is expressed in features (i.e., ABS) that are phenotypes. The phenotypes change due to environmental factors.

Genetic information refers to, e.g., DNA encodings that are hereditary in humans, the structure components of a building, etc. Environment data refers to the ecology of an entity, e.g., temperature, lighting, etc. The sensor data S, once fed into a model will result in the generation of “state” information for the associated entity. The state information may include both somatic (i.e., physical/physiological changes and effects) and afferent/affective (i.e., cognitive and emotional changes and effects) results. Thus for instance, the temperature, humidity level and/or lighting level of a room in a building may be inputted to an entity model associated with an employee working in that room. Based on previous training, the model may determine that the employee generally performs better when the temperature is a few degrees cooler. This information may then be forwarded to an entity model associated with the building to determine if an adjustment is warranted.

Control system 38 is generally responsible for evaluating responses from models, outputting control instructions back to the actual enterprise entities 12, and monitoring and reporting the wellbeing of the enterprise 11. Thus, for example, if it is determined that the temperature of a room in a building 16 should be changed to accommodate a particular person, control system 38 causes the necessary change to be made by interfacing with the HVAC control system of the building 16. Any type of monitoring and reporting output could be generated, e.g., a dashboard showing various wellbeing vital signs (e.g., employee health, building maintenance costs, profit, etc.).

The Human imbedded Grid concept goes beyond the pure hardware and software based grid computing model by imbedding the human being as an additional extremely important resource whose unique capabilities have to be leveraged. Within this framework, each human being bestows his or her intellectual capital (i.e., “brain-ware”) and passion to accomplish an assigned task or set of tasks which may for instance depend on the current affective and somatic state of the person, the person's specific preferences and restrictions, the person's availability and utilization degree, etc. For instance, most human beings have preferences about the kind of work they would like to perform, but cannot fully satisfy this preference in their current job role for any number of reasons, e.g., it is not the core focus of their work unit, the preferences are changing over time, preferences, which were originally congruent, diverged over time due to organizational adjustments, the employee likes the job functions overall but would like to explore his or her unused capabilities once in a while, etc.

In one illustrative implementation, the person could publish and nurture preferences via a database (which could be another node in the enterprise grid 26). This database would for instance provide information for a task scheduler whether a request to fulfill a task matches the preferences of the person. If so, the person could be contacted as a candidate to fulfill the task. In the same database the person could make restrictions to avoid the scheduler overwhelming him or her with requests.

In addition to the enterprise entities 12, enterprise 11 utilizes a strategic plan 24 (e.g., business plan) that dictates how each of the entities 12 and organizational aspects mesh, e.g., using a top down approach. The resulting structure, when modeled as described herein forms the enterprise grid 26. Features of the enterprise grid structure include the following:

1. Organizational “Parent” Models—probabilistic neural networks derived from the strategic plan or goals;
2. Entity “Child” Models—modeled components within the grid such as a human, computer, network, building, etc.;
3. Model Inheritance Module—the methodology of producing one grid model, i.e., every model must be a child of the strategic plan 24;
4. Entity and Organization Model Training/Updates—offline approach for training entity models;
5. Epidemiological Model Construction—during system execution, outputs of health and wellness models (grid model constituent parts) provide trend information for epidemiological information;
6. Entity feedback adapter—the loop back system for changing the grid ecosystem through back propagation of error.

The result is a system that provides a homogenous enterprise grid wellness optimization with heterogeneous entities; provides clandestine salutogenesis (i.e., as part of a bigger system, each entity is slowly moved within the grid to satisfy the multi objective wellness goal); from a human perspective, provides decreased health cost, better work place morale, reduced absenteeism, increased productivity, reduced sick leave, improved performance, decreased health insurance costs, etc.; from a systems approach, provides increased green presence, security, performance with a decreased cost.

In one embodiment, a series of probabilistic neural networks (PNN's) actively learn the patterns of an entity 12 to train an associated entity model. The supervised learned features from each entity model are used to build feature vectors for the next layer of PNN's. Each subsequent PNN layer that is of a different entity is a parent model. Each child model inherits from the parent model. Each entity can inherit from a plurality of parents. Moving towards the top, the parent PNN (i.e., organizational) models are derived from a strategic plan 24. The highest level of the model evaluates if a cumulative pattern is leading towards an optimal grid. In essence, each PNN is an objective within a multi-objective optimization problem.

The summation of all models produces an enterprise grid model that is derived from the strategic plan 24. Organizational models are trained on an accumulation of business data such that the machine learned patterns provide an end state goal of the enterprise grid 26. For example, within a food production facility, a multi objective criteria might include a certain number of tons of production per day at a given quality level. Entities such as employees will be monitored to ensure that their current homeostatic state conforms to the business goal. If not, employees can be assigned different tasks or perhaps asked to change jobs. Alternatively, the environment can be changed to increase wellbeing to meet the multi objective criteria.

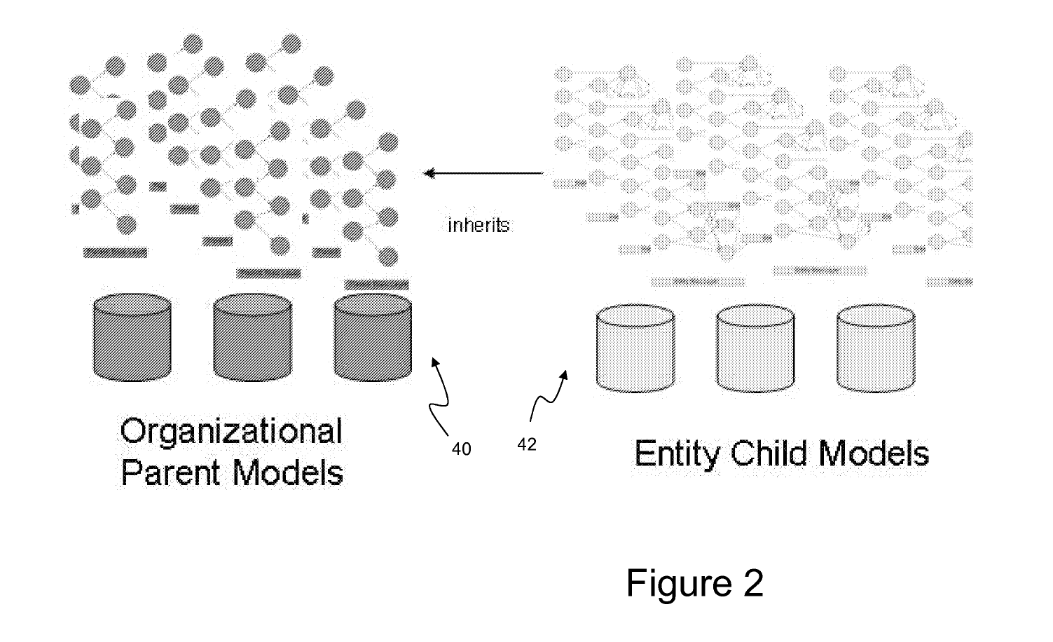

As shown in FIG. 2, the entity child models 42 inherit the output layers of a neural network from organizational parent models 40 that have, a priori, been trained on business goals. As an employee is monitored, the optimal work state of the employee as defined within an employee model will be measured along with a deviation from an organization's goals.

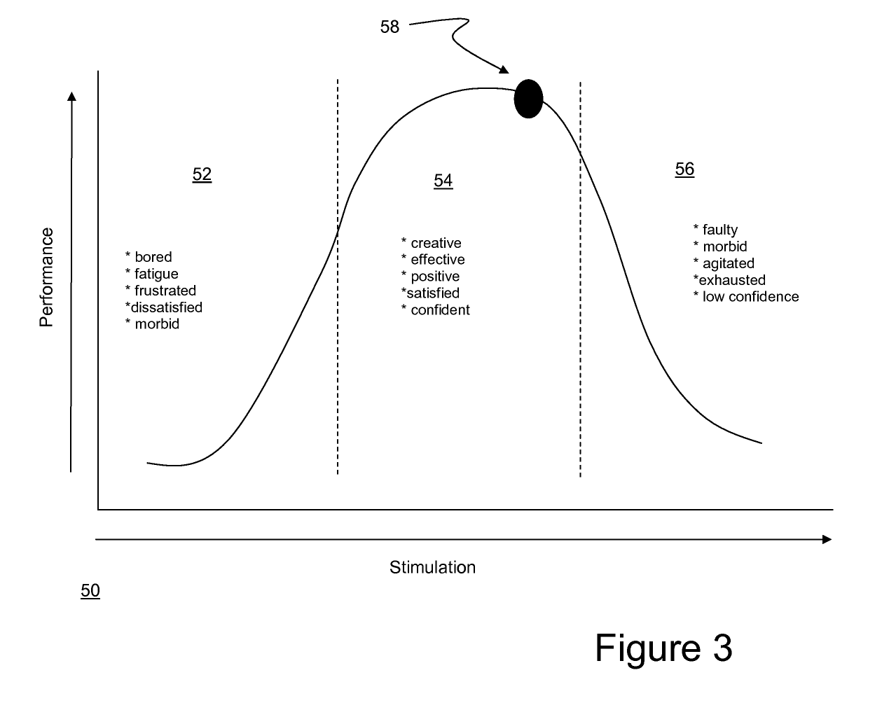

FIG. 3 depicts an employee stimulation zone monitoring system 50. In this embodiment, it can be seen that there are three stimulation zones, under-stimulated 52, optimum stimulation 54 and over-stimulated 56. In this case, it is seen that the state 58 of the employee is in the optimum stimulation zone 54, which may for example be determined by monitoring the employee's pulse, heart-rate, temperature, etc. If for example, the employee's state was under-stimulated, changes to the environment (e.g., the office) could be implemented, e.g., changing the temperature, lighting, sound, etc.

Accordingly, in one embodiment, the medical biometric human signatures can be monitored and converted into feature vectors. The feature vectors are input into a trained multi layer neural network or any other type of model. The output of the neural network determines a somatic and afferent characterization feature vector. Through model inheritance, the somatic and afferent feature vectors are forward pushed into a organizational model. The output of the macro model determines if the user's current somatic and afferent states are matched towards the organizational models.

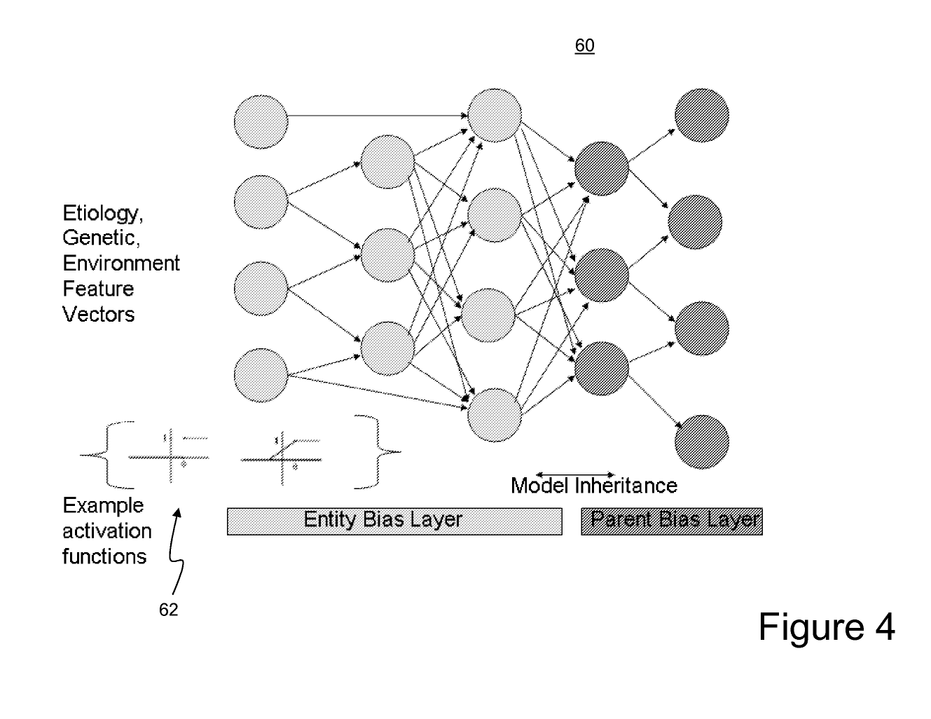

FIG. 4 depicts the integration of the entity and parent models 60 with a suite of activation functions 62. The activation functions are included during training and hoisted onto the model during execution. The entity bias layers enable the weighting of each node. The bias layers enable the priority of groups/entities to be established. If entity A is more important than entity B, the bias weight will higher. Priority and precedence levels are envisioned where the linear aggregation of features are combined utilizing the bias layers.

The dynamic aspect of the system enables the handling of entropy within the entire end to end system. Each model is constantly adjusting and changing to the current or projected business environment, employee health and/or entity state. At a user specified threshold, each model is updated on the grid.

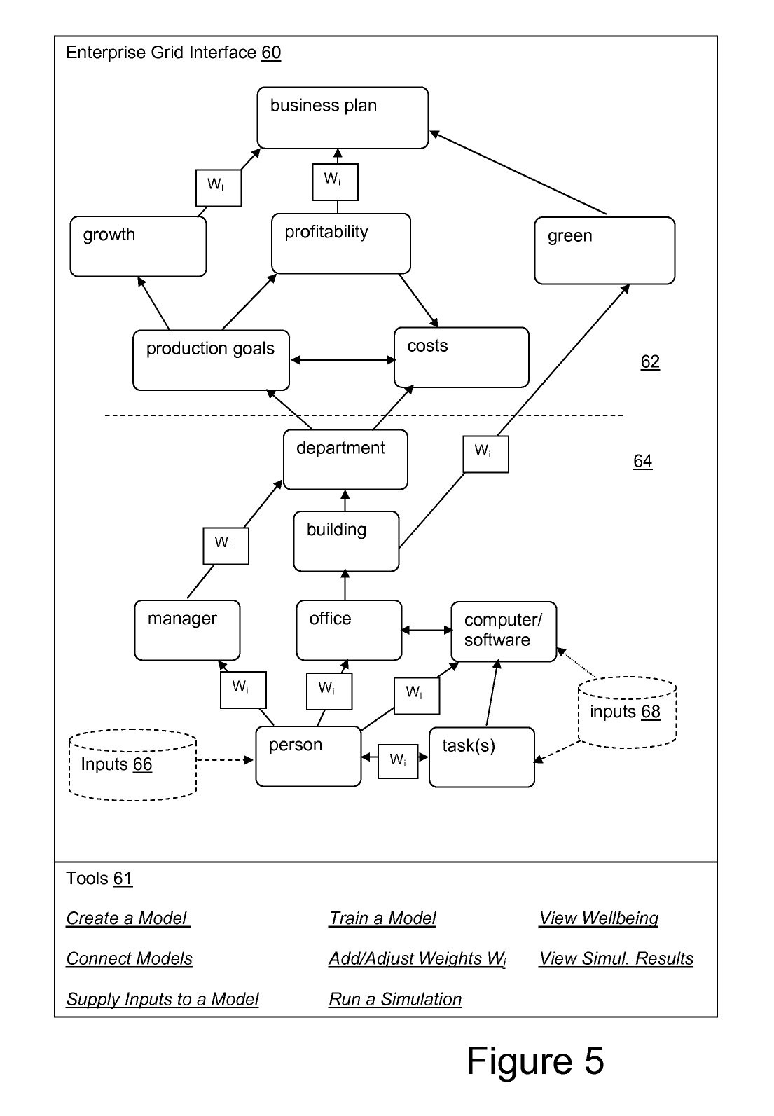

FIG. 5 depicts an illustrative enterprise grid interface 60 for allowing a user to manage the interface grid. The enterprise grid interface 60 includes lower viewing portion that depicts entity models, including person, task(s), manager, office, computer/software, building and department; and an upper viewing portion that depicts organizational models including production goals, costs, profitability, growth, green, and at the top, business plan. As shown by way of example, inputs 66 are injected to the person model, which in turn can generate inputs into parent entity models, manager, office and computer/software. The office model may then generate outputs to the building model, which may generate outputs to the department model. The department model may generate outputs to the product goals and costs models, which may generate outputs to the profitability model, and finally to the business plan model at the top.

Other inputs 68 may be injected to any of the other models. In one scenario, inputs 66, 68 may be actual inputs obtained from real world sensors. In another scenario, inputs 66, 68 may be simulated inputs to determine the business impact, i.e., wellbeing impact. In addition to inputs 66, 68, weights wᵢ may be assigned to connectors between models to adjust the impact. For instance, the office an employee is assigned to may be more or less important than the manager assigned to the employee, or the output from an experienced employee may be assigned a greater weight than that of an inexperienced employee.

Within interface 60, the user is able to utilize a set of tools 61 to, e.g., create a model, connect models, supply inputs to models, train models, add/adjust weights, run simulations, view wellbeing reports, and view simulation results. Obviously, FIG. 5 depicts one of many possible embodiments for creating and managing an enterprise grid as described herein.

Accordingly, the described solution provides a dynamic inheritance model structure that mimics object orientation for data fusion; core business models that are derived from a business or strategic plan; a grid that constitutes digital and human organic computing cycles; a grid that constitutes an environment such as a building, a car, etc.; and a system that monitors all constituent parts of the grid.

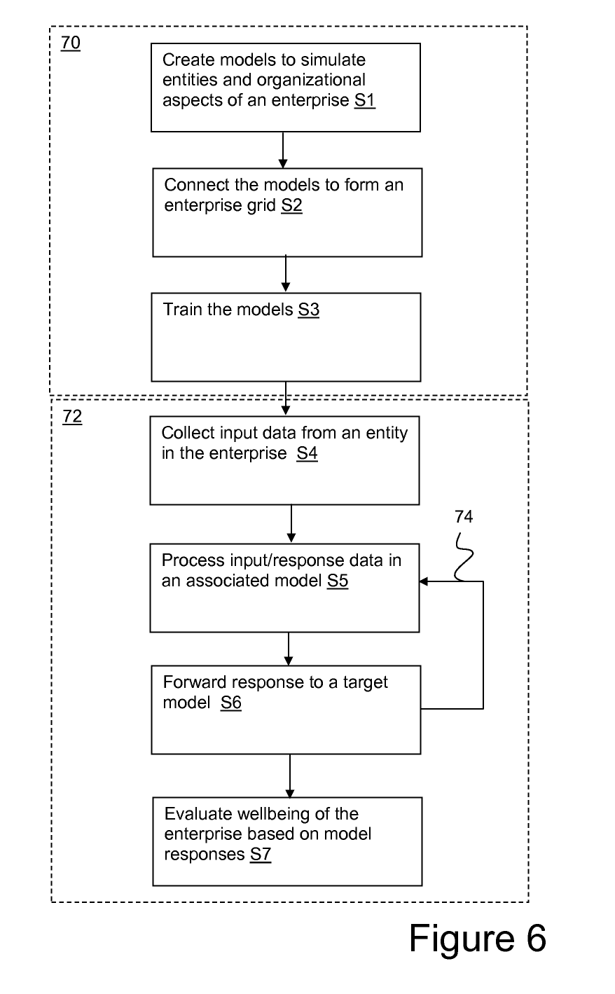

FIG. 6 depicts a flow chart showing a method of implementing a wellness system. Steps S1-S3 represents steps generally implemented in an off-line mode 70, while steps S4-S7 represent steps generally implemented in an on-line mode 72. At S1, models are created to simulate entities and organizational aspects of the enterprise. At S2, models are connected to form an enterprise grid. In general, models are connected in a hierarchical fashion such that an output of a source model can only be directed to a target model either at a same hierarchical level or at a parent level. At S3, models are trained. Note that while the training of models is initially accomplished in the off-line mode 70, additional training can occur during on-line mode 72 operations.

At S4, input data is collected from an entity (e.g., a human, a machine, a building, etc.) in the enterprise. At S5, the input data is processed by an associated model and at S6 the response is forwarded to a target model. This procedure of receiving, processing and forwarding data runs in an ongoing manner 74 to allow model responses to perpetuate up through the grid hierarchy. At S7, the wellbeing of the enterprise is evaluated based on the model responses.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including Instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for implementing an enterprise grid to model an enterprise, comprising:
a system for creating a set of models, wherein a set of entity models are utilized to model entities within the enterprise and a set of organizational models are utilized to model organizational aspects of the enterprise, and wherein at least one class of entity models are utilized to model humans;
a system for connecting models to form the enterprise grid such that an output of a source model is only directed to a target model either at a same hierarchical level or at a parent level;
a system for training models;
a system for receiving an input from an entity within the enterprise and forwarding the input to an associated entity model.

2. The system of claim 1, wherein the entity models are further utilized to model entities selected from a group consisting of: resources, buildings, offices, software, computers, employee roles, tasks, projects, departments, and divisions.

3. The system of claim 1, wherein the organizational models are utilized to model aspects selected from a group consisting of: business goals, profitability, production, environmental goals, growth, accounting, revenue, costs, and strategies.

4. The system of claim 1, wherein each model comprises a neural network.

5. The system of claim 1, further comprising a system for assigning weights between connected models to magnify or diminish an effect of the output between a source model and a target model.

6. The system of claim 1, further comprising a system for simulating inputs into models.

7. The system of claim 1, further comprising a system for monitoring a state of one or more models in response to a current set of inputs.

8. A method for implementing an enterprise grid to model an enterprise, comprising:
creating a set of models, wherein a set of entity models are utilized to model entities within the enterprise and a set of organizational models are utilized to model organizational aspects of the enterprise, and wherein at least one class of entity models are utilized to model humans;
connecting models to form the enterprise grid such that an output of a source model is only directed to a target model either at a same hierarchical level or at a parent level;
training models; and
receiving an input from an entity within the enterprise and forwarding the input to an associated entity model.

9. The method of claim 8, wherein the entity models are further utilized to model entities selected from a group consisting of: resources, buildings, offices, software, computers, employee roles, tasks, projects, departments, and divisions.

10. The method of claim 8, wherein the organizational models are utilized to model aspects selected from a group consisting of: business goals, profitability, production, environmental goals, growth, accounting, revenue, costs, and strategies.

11. The method of claim 8, wherein each model comprises a neural network.

12. The method of claim 8, further comprising assigning weights between connected models to magnify or diminish an effect of the output between a source model and a target model.

13. The method of claim 8, further comprising simulating inputs into models.

14. The method of claim 8, further comprising monitoring a state of one or more models in response to a current set of inputs.

15. A computer program product for implementing an enterprise grid to model an enterprise, the computer program product comprising:
a computer readable storage medium having computer readable program code embodied therewith, the computer readable program code comprising:
program code for creating models to form the enterprise grid, wherein a set of entity models are utilized to model entities within the enterprise and a set of organizational models are utilized to model organizational aspects of the enterprise, and wherein at least one class of entity models are utilized to model humans;
program code for connecting models such that an output of a source model is only directed to a target model either at a same hierarchical level or at a parent level;
program code for training models; and
program code for receiving an input from an entity within the enterprise and forwarding the input into an associated entity model.

16. The computer program product of claim 15, wherein the entity models are further utilized to model entities selected from a group consisting of: resources, buildings, offices, software, computers, employee roles, tasks, projects, departments, and divisions.

17. The computer program product of claim 15, wherein the organizational models are utilized to model aspects selected from a group consisting of: business goals, profitability, production, environmental goals, growth, accounting, revenue, costs, and strategies.

18. The computer program product of claim 15, wherein each model comprises a neural network.

19. The computer program product of claim 15, further comprising assigning weights between connected models to magnify or diminish an effect of the output between a source model and a target model.

20. The computer program product of claim 15, further comprising simulating inputs into models.

21. The computer program product of claim 15, further comprising monitoring a state of one or more models in response to a current set of inputs.
